(19) United States
(12) Patent Application Publication
(10) Pub. No.: US 2008/0193591 A1
(43) Pub. Date: Aug. 14, 2008

(54) Taste Improving Agent for Food and Beverage Containing Potassium Chloride, Process for Producing Food and Beverage Containing Potassium Chloride and Food and Beverage Containing Potassium Chloride Produced by the Process

(75) Inventors: Takuro Wada, Shizuoka (JP); Hideki Matsuda, Shizuoka (JP); Yusuke Akahori, Shizuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Yaizu Suisankagaku Industry Co., Ltd., Yaizu-shi (JP)

(21) Appl. No.: 11/908,924

(22) PCT Filed: Dec. 26, 2005
(86) PCT No.: PCT/JP05/23814

§ 371 Date: Sep. 17, 2007

(51) Int. Cl. A23L 1/22; A23L 1/237; A23L 1/238

(52) U.S. Cl. 426/7; 426/649

(57) ABSTRACT

A taste improving agent for food and beverage containing potassium chloride that can effectively relieve unpleasant tastes, such as bitter taste and harsh taste, attributed to potassium chloride without detriment to the flavor of the food and beverage; a process for producing a food and beverage containing potassium chloride of high palatability having the bitter taste and harsh taste of potassium chloride suppressed; and a food and beverage containing potassium chloride produced by the production process. Use is made of a taste improving agent comprising a basic amino acid and/or a basic peptide as an active ingredient. It is preferred that the basic amino acid be at least one member selected from among histidine, arginine and lysine and the basic peptide at least one member selected from among anserine, carnosine and balenine. This taste improving agent is added to a food and beverage containing potassium chloride, thereby obtaining a food and beverage containing potassium chloride with improved taste.

### TECHNICAL FIELD

The present invention relates to: a taste-improving agent for food and beverage containing potassium chloride that can effectively alleviate unpleasant tastes, such as bitter taste and harsh taste, attributed to potassium chloride without detriment to the flavor of the food and beverage; a process for producing food and beverage containing potassium chloride of high palatability having the bitter taste and harsh taste of potassium chloride suppressed; and food and beverage containing potassium chloride produced by the production process.

### BACKGROUND ART

Salt is widely used for food preservation or as a seasoning or the like, but an excessive salt intake is known to lead to degenerative diseases such as high-blood pressure, heart disease, and cerebral stroke. In recent years, reduced-salt processed foods or beverages are desired from the viewpoint of health.

So-called reduced-salt food and beverage, which are obtained by reducing the quantity of salt, has low palatability due to lack of salty taste, and therefore various salt alternatives have been studied. Among them, potassium chloride has salty taste and has an effect of promoting excretion of sodium ion, and it is used as a typical component of the salt alternatives.

For example, one of typical seasonings, soy sauce, contains a relatively large amount of salt, and thus there are many reduced-salt soy sauces with reduced salt contents on sale.

Various processes for producing such reduced-salt soy sauces are known, which include processes for desalting a normal soy sauce by electrodialysis or using a membrane treatment apparatus and the process described in Patent Document 1 below, which relates to a process for producing a low-salt soy sauce and discloses a process for producing a low-salt or reduced-salt brewed soy sauce, which is characterized by including: preparing soy sauce koji using, as a soy sauce koji bacterium, a shochu koji bacterium selected form Aspergillus kawachii, Aspergillus saitoi, Aspergillus usamii, and Aspergillus awamori, which have excellent organic acid-producing abilities; charging the koji; and adjusting the pH of moromi to 3.5 to 4.5 when charging and adjusting the concentration of charge salt water in the charge step so that the salt concentration of the moromi liquid is 6 to 12% (w/v) to prevent decay of the moromi; and performing fermentation and aging.

Meanwhile, Patent Document 2 below discloses a process for producing a low-salt soy sauce, which is characterized by including: charging soy sauce koji in a charging solution containing 1 to 5% alcohol in an amount to attain the salt concentration of 9 to 12% and the nitrogen concentration of 2.0 to 2.5% in a moromi liquid after aging; and performing fermentation and aging in accordance with conventional methods.

However, the above-described soy sauce tends to have an unsatisfactory taste due to insufficient salty taste caused by reducing the salt amount. Therefore, in order to improve the salty taste, potassium chloride has been added as a salt alternative. However, potassium chloride has unpleasant tastes such as bitter taste and harsh taste, and a reduced-salt soy sauce with a well-satisfactory taste could not be obtained.

On the other hand, there has been developed a reduced-salt soy sauce having alleviated unpleasant tastes of potassium chloride, for example, Patent Document 3 below discloses a functional salt composition, which is characterized by: being obtained by mixing 5 to 60 parts by weight of a citrate in 100 parts by weight of a mixture including 30 to 75% by weight of salt and 25 to 70% by weight of potassium chloride; and having a Na/K ratio of 1 or less, and the document discloses a soy sauce prepared by using the functional salt composition.

Meanwhile, Patent Document 4 below discloses a food characterized by containing potassium ion and a sugar alcohol except for reduced maltose starch syrup and having a weight ratio of potassium ion:sugar alcohol of 1:3 to 50, and the document shows a soy sauce as an example of the food.

In addition, Patent Document 5 below discloses a liquid seasoning which has a potassium chloride content of 3 to 20 g/dL, a potassium chloride content of 1.5 to 17 g/dL, and a Na/K weight ratio of 2 or less and contains a sugar and/or a kelp extract, and the document shows a soy sauce as an example of the liquid seasoning.

Meanwhile, Patent Document 6 below discloses a reduced-salt soy sauce having a salt concentration of 9 w/w % or less, a potassium concentration of 0.5 to 3.7 w/w %, and a nitrogen concentration of 1.9 w/v % or more.

Patent Document 7 below discloses a low-salt soy sauce seasoning characterized by blending capsaicin in a reduced-salt soy sauce.

Patent Document 1: JP 06-22459 B

Patent Document 2: JP 05-219915 A

Patent Document 3: JP 2675254 B

Patent Document 4: JP 06-97972 B

Patent Document 5: JP 2002-325554 A

Patent Document 6: JP 2004-357700 A

Patent Document 7: JP 2001-245627 A

### DISCLOSURE OF THE INVENTION

### Problems to be Solved by the Invention

Many agents for suppressing bitter taste and harsh taste of potassium chloride have their own strong tastes, and if sufficient amount of the agents for functioning are added, their own tastes affect foods and beverages. On the other hand, if the agent is added in an amount giving no influence on tastes of foods and beverages, the effect is insufficient and therefore it is very difficult to suppress the bitter taste and harsh taste of potassium chloride without detriment to the taste of the foods and beverages. Therefore, in markets, there are no reduced-salt food and beverage containing potassium chloride of high palatability having the bitter taste and harsh taste of potassium chloride suppressed.

As described in Patent Documents 3 to 5 above, in the case of adding a citrate, a sugar alcohol, a kelp extract, etc. to alleviate unpleasant tastes of potassium chloride, or as described in Patent Document 7 above, in the case of adding capsaicin to improve a salty taste, there is a problem of loss of the umami and flavor of a soy sauce itself due to such a component.

Meanwhile, a process for desalting a normal soy sauce by electrodialysis or using a membrane treatment apparatus is known as a process for producing a reduced-salt soy sauce, and the process has a problem of not only a decrease in the salty taste but also a decrease in a umami component such as an amino acid, resulting in a decrease in the umami and flavor of a soy sauce itself. Therefore, in the case where a reduced-salt soy sauce disclosed in Patent Document 6 above is desalted by electrodialysis or using a membrane treatment apparatus to adjust the nitrogen concentration and potassium concentration, completely satisfactory products cannot be obtained in terms of the umami and flavor.

Therefore, an object of the present invention is to provide: a taste-improving agent for food and beverage containing potassium chloride that can effectively alleviate unpleasant tastes, such as bitter taste and harsh taste, attributed to potassium chloride without detriment to the flavor of the food and beverage; a process for producing food and beverage containing potassium chloride of high palatability having the bitter taste and harsh taste of potassium chloride suppressed; and food and beverage containing potassium chloride produced by the production process.

### Means for Solving the Problems

In order to achieve the above-mentioned object, according to a first invention, there is provided a taste-improving agent for food and beverage containing potassium chloride, including at least one of a basic amino acid and a basic peptide as an active ingredient.

According to a second invention, in the first invention, there is provided a taste-improving agent for food and beverage containing potassium chloride, including as the basic amino acid one or more kinds selected from the group consisting of histidine, arginine, and lysine.

According to a third invention, in the first or second invention, there is provided a taste-improving agent for food and beverage containing potassium chloride, including as the basic peptide one or more kinds selected from the group consisting of anserine, carnosine and balenine.

According to a fourth invention, in any one of the first to third inventions, there is provided a taste-improving agent for food and beverage containing potassium chloride, including the basic amino acid, the basic peptide, or both of the basic amino acid and the basic peptide in an amount of 0.05 to 99% by mass.

According to a fifth invention, in any one of the first to fourth inventions, there is provided a taste-improving agent for food and beverage containing potassium chloride, including as a main ingredient a material of a seafood extract, a yeast extract, HVP, HAP, or a separated and purified product thereof, in which the material contains the basic amino acid, the basic peptide, or both of the basic amino acid and the basic peptide in an amount of 2 to 99% by mass.

According to a sixth invention, in any one of the first to fifth inventions, there is provided a taste-improving agent for food and beverage containing potassium chloride, further including a glutamic acid in an amount of 0.1 to 50% by mass.

According to a seventh invention, in any one of the first to sixth inventions, there is provided a taste-improving agent for food and beverage containing potassium chloride, further including a γ-aminobutyric acid in an amount of 0.1 to 50% by mass.

According to an eighth invention, there is provided a process for producing food and beverage containing potassium chloride, including adding the taste-improving agent according to any one of the first to seventh inventions.

According to a ninth invention, in the eighth inventions, there is provided a process for producing food and beverage containing potassium chloride, in which the taste-improving agent is added such that a basic amino acid, a basic peptide, or both of a basic amino acid and a basic peptide is contained in an amount of 0.2 to 200 parts by mass with respect to 100 parts by mass of potassium chloride.

According to a tenth invention, in the eighth or ninth invention, there is provided a process for producing food and beverage containing potassium chloride, in which the taste-improving agent is added to food and beverage which has a potassium chloride/sodium chloride mass ratio of 5/95 to 80/20.

According to an eleventh invention, in any one of the eighth to tenth inventions, there is provided a process for producing food and beverage containing potassium chloride, in which the food and beverage containing potassium chloride comprises a soy sauce product, the process further including: in a brewing process, preparing a charging liquid having a sodium chloride content of 20% by mass or less and a potassium chloride content of 2 to 18% by mass; performing fermentation and aging of the charging liquid to produce a soy sauce; adding the taste-improving agent to the soy sauce such that the basic amino acid, the basic peptide, or both of the basic amino acid and the basic peptide is added in an amount of 0.01 to 1.0% by mass.

According to a twelfth invention, in any one of the eighth to tenth inventions, there is provided a process for producing food and beverage containing potassium chloride, in which the food and beverage containing potassium chloride comprises a soy sauce product, the process further including: in a brewing process, preparing a charging liquid having a sodium chloride content of 20% by mass or less and a potassium chloride content of 2 to 18% by mass; adding the taste-improving agent to the charging liquid such that the basic amino acid, the basic peptide, or both of the basic amino acid and the basic peptide is added in an amount of 0.01 to 1.0% by mass; and performing fermentation and aging of the charging liquid to produce a soy sauce.

According to a thirteenth invention, in the eleventh or twelfth invention, there is provided a process for producing food and beverage containing potassium chloride, in which the basic amino acid comprising histidine, arginine, and lysine is added in amounts of 0.002 to 0.3% by mass, 0.004 to 0.7% by mass, and 0.006 to 1.0% by mass, respectively.

According to a fourteenth invention, in any one of the eleventh to thirteenth inventions, there is provided a process for producing food and beverage containing potassium chloride, further including adding a glutamic acid in an amount of 0.06% by mass or more.

According to a fifteenth invention, in any one of the eleventh to fourteenth inventions, there is provided a process for producing food and beverage containing potassium chloride, further including adding a γ-aminobutyric acid in an amount of 50 ppm or more.

According to a sixteenth invention, in any one of the eighth to tenth inventions, there is provided a process for producing food and beverage containing potassium chloride, in which the food and beverage containing potassium chloride comprises a soy sauce product, the process further including: i) adding a potassium salt to a soy sauce, the sodium salt content of the soy sauce adjusted by desalting, wherein the potassium salt is added in an amount corresponding to 9% (w/w) or more of the reducing value of sodium salt amount, ii) adjusting a glutamic acid content to at least a value before the adjustment by desalting, and iii) adjusting: an arginine content to −20 to +200 mg/100 g relative to that before the adjustment by desalting; a histidine content to −10 to +100 mg/100 g relative to that before the adjustment by desalting; and a lysine content to −30 to +300 mg/100 g relative to that before the adjustment by desalting.

According to a seventeenth invention, in the sixteenth invention, there is provided a process for producing food and beverage containing potassium chloride, further including adjusting a γ-aminobutyric acid content to 50 ppm or more and a glutamic acid content to 800 mg/100 g or more.

According to an eighteenth invention, there is provided food and beverage containing potassium chloride, including the taste-improving agent according to any one of the first to seventh inventions.

According to a nineteenth invention, in the eighteenth invention, there is provided food and beverage containing potassium chloride, which contains the taste-improving agent so that a basic amino acid and a basic peptide is contained in an amount of 0.2 to 100 parts by mass with respect to 100 parts by mass of potassium chloride.

According to a twentieth invention, in the eighteenth or nineteenth invention, there is provided food and beverage containing potassium chloride, which has a potassium chloride/sodium chloride mass ratio of 5/95 to 80/20.

According to a twenty first invention, in any one of the eighteenth to twentieth inventions, there is provided food and beverage containing potassium chloride, which comprises a soy sauce product obtained by the production method according to any one of the eleventh to fifteenth inventions and having a sodium chloride content of 9% by mass or less.

According to a twenty-second invention, in any one of the eighteenth to twentieth inventions, there is provided food and beverage containing potassium chloride, which comprises a soy sauce product obtained by the production method according to the sixteenth or seventeenth invention and having a salt content of 3 to 15% (w/w) in terms of sodium, a potassium chloride content of 13% (w/w) or less, a glutamic acid content of 500 to 5,000 mg/100 g, an arginine content of 5 to 1,000 mg/100 g, a lysine content of 5 to 1,000 mg/100 g, and a histidine content of 5 to 500 mg/100 g.

According to the first taste-improving agent of the present invention, it is possible to effectively alleviate unpleasant tastes, such as bitter taste and harsh taste, attributed to potassium chloride in food and beverage containing potassium chloride without detriment to the taste of the food and beverage.

According to the second to sixth taste-improving agents of the present invention, it is possible to more effectively alleviate unpleasant tastes of potassium chloride without reducing the umami and flavor of food and beverage containing potassium chloride.

According to the seventh taste-improving agent of the present invention, it is possible to yield more delicious food and beverage containing potassium chloride because of salty taste enhancing effect of GABA, and further to expect a physiologically active effect of GABA, such as an effect for lowering blood pressure.

According to the eighth process for producing food and beverage containing potassium chloride of the present invention, it is possible to produce food and beverage containing potassium chloride of high palatability having the bitter taste and harsh taste of potassium chloride suppressed.

According to the ninth and tenth processes for producing food and beverage containing potassium chloride of the present invention, it is possible to more effectively alleviate unpleasant tastes of potassium chloride without reducing the umami and flavor of food and beverage containing potassium chloride.

According to the eleventh and twelfth processes for producing food and beverage containing potassium chloride of the present invention, it is possible to alleviate unpleasant tastes of potassium chloride by adding predetermined amounts of basic amino acids in or after brewing a soy sauce in which a charging liquid with sodium chloride and potassium chloride concentrations adjusted to predetermined levels is used, and to thereby produce a soy sauce product having salty taste, umami, and a flavor which bear comparison with those of a normal soy sauce.

According to the thirteenth and fourteenth processes for producing food and beverage containing potassium chloride of the present invention, it is more effectively alleviate unpleasant tastes of potassium chloride without reducing the umami and a flavor of an original soy sauce.

According to the fifteenth process for producing food and beverage containing potassium chloride of the present invention, it is possible to produce a more delicious soy sauce product because of salty taste enhancing effect of GABA, and further to expect a physiologically active effect of GABA, such as an effect for lowering blood pressure.

According to the sixteenth process for producing food and beverage containing potassium chloride of the present invention, it is possible to sufficiently impart salty taste to a soy sauce by adding a predetermined amount of a potassium salt, while sodium salt content of the soy sauce being adjusted by desalting. In addition, adjustment of the glutamic acid content and basic amino acid content such as that of arginine, histidine, and lysine to within predetermined ranges can alleviate the unpleasant taste of a potassium salt and impart umami and flavor of an original soy sauce that have been lost by the desalting treatment.

According to the seventeenth process for producing food and beverage containing potassium chloride of the present invention, it is possible to produce a more delicious soy sauce product by preventing a decrease in a flavor because of taste quality improving effect of GABA as well as because of salty taste enhancing effect of GABA. Moreover, it is also possible to expect a physiologically active effect of GABA, such as an effect for lowering blood pressure.

According to the eighteenth to twenty-second food and beverage containing potassium chloride of the present invention, it is possible to produce food and beverage containing potassium chloride of high palatability having the bitter taste and harsh taste of potassium chloride suppressed.

### EFFECT OF THE INVENTION

A taste-improving agent for food and beverage containing potassium chloride of the present invention can effectively alleviate unpleasant tastes, such as bitter taste and harsh taste, attributed to potassium chloride without detriment to the taste of the food and beverage, and therefore it is possible to provide food and beverage containing potassium chloride of high palatability, which bears comparison with a normal food and beverage on salty taste and has the bitter taste and harsh taste of potassium chloride suppressed.

### BEST MODE FOR CARRYING OUT THE INVENTION

A process for producing food and beverage containing potassium chloride of the present invention is characterized by adding a taste-improving agent containing a basic amino acid and/or a basic peptide as an active ingredient to food and beverage containing potassium chloride.

In the present invention, the “food and beverage containing potassium chloride” are not particularly limited as long as they are food and beverage containing potassium chloride, and examples thereof include reduced-salt food and beverage obtained by substituting a part of salt for potassium chloride. Preferable are food and beverage with a potassium chloride/sodium chloride mass ratio of 5/95 to 80/20, more preferable are food and beverage obtained by substituting 5 to 80% by mass of salt in an objective food and beverage for potassium chloride, particularly preferable are food and beverage obtained by substituting 40 to 60% by mass of salt in an objective food and beverage for potassium chloride.

Note that potassium chloride is not particularly limited as long as it is allowed to foods, and for example, highly-pure potassium chloride may be used. Moreover, it may be a crude product containing other minerals such as sodium, calcium, and magnesium.

Specific examples of food and beverage containing potassium chloride include: a normal soy sauces such as light soy sauce, dark soy sauce, tamari soy sauce, saishikomi soy sauce, and white soy sauce in Japan Agricultural Standards (JAS); liquid seasonings such as soy sauce products, which are obtained by adding sweet cooking rice wine, miso, other seasonings, acidulant, sweetener, flavor, stock, or extracts to the above-described soy sauces; seasonings such as miso, salt, and flavor seasoning; and general processed foods containing such seasonings, such as 1) semi-prepared foods including a base of bean curd with minced beef chili sauce, a base of shredded pepper steak, a base of prawn in chili sauce, a base of egg with crab meat, curry roux, and stew roux; 2) confectioneries including snacks, potato chips, and rice biscuits; 3) rice foods such as a base of rice dish, a base of mix rice such as rice ball or mixed sushi and thin strips of egg on rice and toasted rice ball; 4) prepared foods such as curry, stew, soup, pasta sauce, fried chicken, spring roll, meat ball, chinese stuffed dumplings, chinese steamed dumplings, beef bowl ingredients, chicken and eggs bowl ingredients, chinese bowl ingredients, cooked fish, meat, and vegetables, and products boiled down in soy sauce (tsukudani); 5) seasonings such as sauces for barbecued meat, stock soup of nabe, stock soup of oden, stock soup of noodles such as udon, buckwheat noodles, and fine noodles, sauce of cooked dishes of fish, meat, vegetables, etc., dressing, citrus sauce (ponzu), fermented soybeans (natto) sauce, sauce to be diluted with water when used; 6) noodles such as salt chinese noodles (ramen), miso chinese noodles (ramen), soy-sauce chinese noodles (ramen), sauce pan-fried noodles, salt pan-fried noodles, bean-starch noodles, chinese rice noodles, pasta, annkake noodles, udon, buckwheat noodles, fine noodles, and instant noodles thereof; and 7) pickles, pickled Japanese vegetables, seasoned powder for sprinkling on rice (furi-kake), seafood delicacies, and fish/meat products including can, ham, and sausage.

Next, the taste-improving agent for food and beverage containing potassium chloride of the present invention will be described.

The taste-improving agent for food and beverage containing potassium chloride of the present invention may be one containing a basic amino acid and/or a basic peptide as an active ingredient.

In the present invention, the basic amino acid means one that has a basic side chain and exhibits a basic pH when it is in a state of aqueous solution where it does not form a salt, and examples thereof preferably include histidine, arginine, lysine, and their hydrochlorides, acetates, lactates, sulfates, nitrates, and phosphates. They may be used singly or in combination of two or more, and a combination of two or more is more preferably used.

Meanwhile, the basic peptide means a peptide obtained by linearly linking 2 to 5 amino acids, which has a basic amino acid at least at the end and exhibits a basic pH when it is in a state of aqueous solution where it does not form a salt, and examples thereof preferably include anserine, carnosine, balenine, and their hydrochlorides, acetates, lactates, sulfates, nitrates, and phosphates. They may be used singly or in combination of two or more, and a combination of two or more is more preferably used.

The basic amino acid and/or basic peptide may be used in combination depending on types of objective food and beverage, and examples of the combination include a combination of histidine, arginine, and lysine or a combination of histidine and an imidazole dipeptide (anserine, carnosine, or balenine).

A source of the basic amino acid and/or basic peptide may be an extract containing the basic amino acid and/or basic peptide to be used in general processed foods, examples thereof preferably include a seafood extract, a yeast extract, HVP, and HAP.

Examples of the seafood extracts include: fish extracts obtained from skipjack, dried skipjack, tuna, dried tuna, mackerel, dried mackerel, sardine, dried sardine, salmon, and the like; shellfish extracts obtained by scallop, oyster, freshwater clam, clam, and the like; crustacean extracts obtained by shrimp, crab, and the like; other extracts obtained by whale, dolphin, seal, and the like. In particular, the fish extracts obtained by skipjack and tuna are preferable because they contain not only histidine but also anserine.

Meanwhile, examples of the yeast extract include beer yeast extract, bread yeast extract, torula yeast extract, and other yeast extracts.

Moreover, the HVP can be obtained by hydrolyzing a plant protein such as soybean, wheat, barley, or corn.

Furthermore, the HAP can be obtained by hydrolyzing an animal protein such as animal meat, fish meat, or gelatin.

The basic amino acid and/or basic peptide content is preferably 0.05 to 99% by mass.

As a basic amino acid and/or a basic peptide in the present invention, it is possible to use a material obtainable by separation and purification of the above-described seafood extract, yeast extract, HVP, or HAP, the material containing a basic amino acid and/or a basic peptide in an amount of 2 to 99% by mass.

A process of separation and purification for the above-described extracts may be a known one, which includes a process using electrodialysis, ultrafiltration membrane, reverse osmosis membrane, UF membrane, RO membrane, ion-exchange resin, activated carbon, etc., and for example, a method disclosed in JP 2003-92996 A may be employed. Among them, since specific collection of a basic fraction can be performed, a process using an ion-exchange resin is preferable.

The taste-improving agent for food or beverage containing potassium chloride of the present invention preferably further contains 0.05 to 99% by mass of glutamic acid, more preferably contains 0.1 to 50% by mass of glutamic acid. Addition of the predetermined amount of glutamic acid can effectively alleviate the bitter taste and harsh taste of potassium chloride, an amino acid, and the like, thereby yielding food and beverage containing potassium chloride having more excellent umami and flavor.

A source of glutamic acid may be purified glutamic acid and glutamates, and it is preferable to use not only glutamic acid but also a seafood extract, a yeast extract, HVP, and HAP containing the basic amino acid and/or basic peptide, or products obtained by separation and purification of them using UF membrane, RO membrane, ion-exchange resin, activated carbon, and the like.

Meanwhile, the taste-improving for food or beverage agent containing potassium chloride of the present invention preferably further contains γ-aminobutyrate (GABA) in an amount of 0.1 to 50% by mass, and in views of its effect of improving quality of taste, effect of enhancing salty taste, and effect of lowering blood pressure, the agents preferably contains GABA in an amount of 0.5 to 25% by mass.

GABA is a non-protein constituting amino acid that is widely present in animals and plants, and is known to be generated by decarboxylation of glutamic acid in a living body, play an important role as an inhibitory transmitter in central nerve system, and have a physiological function such as an effect of lowering blood pressure. GABA is known to have seasoning functions such as an effect of enhancing salty taste (see JP 2004-275097A) and an effect of improving quality of taste (see JP 2004-275098 A). However, if GABA is added to food and beverage containing potassium chloride, a taste of an amino acid tends to be modified even to deteriorate the flavor. However, if the GABA content is within the above-described range, a salty taste can be more effectively enhanced by the effect of enhancing salty taste of GABA without reducing the flavor. In addition, a synergistic effect of a bioactive effect of GABA such as an effect of lowering blood pressure and an effect of reducing salt can be expected.

GABA may be a commercially available product such as a product named “PHARMA GABA” (manufactured by Pharma Foods International Co., Ltd.) and a product named “Rice Germ GABA” (manufactured by Taimatsu-Syokuhin Co., Ltd.).

The taste-improving agent for food and beverage containing potassium chloride of the present invention may be used in combination with an amino acid such as alanine, glycine, or sodium glutamate, a mushroom extract, a mineral, an organic acid, etc.

The amount of the taste-improving agent to be added to food and beverage containing potassium chloride may be appropriately determined depending on the type of a basic amino acid and/or a basic peptide, a combination thereof, and the type of objective food and beverage, and a basic amino acid and/or a basic peptide is added to 100 parts by mass of potassium chloride preferably in an amount of 0.2 to 200 parts by mass, more preferably in an amount of 1 to 100 parts by mass.

If the taste-improving agent is added to 100 parts of potassium chloride in an amount less than 0.2 part by mass, unpleasant tastes such as bitter taste and harsh taste attributed to potassium chloride can be improved little, while if the agent is added in an amount more than 100 parts by mass, the flavor of the taste-improving agent becomes strong, resulting in a reduction in the flavor of the resultant food and beverage.

Meanwhile, in a case where a combination of the basic amino acid and/or basic peptide includes histidine, arginine, and lysine, the above-described taste-improving agent is preferably added to food and beverage containing potassium chloride so that the food and beverage contain histidine in an amount of 0.2 to 2% by mass, arginine in an amount of 0.5 to 5% by mass, and lysine in an amount of 1.0 to 10% by mass. Meanwhile, in a case where histidine and imidazole dipeptides (anserine, carnosine, and balenine) are used in combination, the taste-improving agent is preferably added to potassium chloride so that histidine is contained in an amount of 0.2 to 60% by mass, and that imidazole peptide is contained in an amount of 0.15 to 40% by mass.

Next, embodiments of the process for producing food and beverage containing potassium chloride of the present invention will be described using a case where the food and beverage containing potassium chloride is a soy sauce product obtained from dark soy sauce. Note that, in cases of light colored soy sauce, tamari soy sauce, saishikomi soy sauce, white soy sauce, and the like, it is possible to perform the process in accordance with normal production methods for the respective soy sauces.

A pretreatment of a material and production of koji can be performed in accordance with normal methods. That is, soybeans are steamed after an appropriate amount of water is added, while the family of wheat such as wheat (hereinafter, referred to as wheat or the like) is roasted, followed by grinding. The soybeans and wheat or the like are mixed after the pretreatment, and seed koji is inoculated to produce koji.

In accordance with a conventional method, a charging liquid is added to koji to produce moromi, followed by fermentation and aging. In this aspect, the sodium chloride concentration in the charging liquid is adjusted to 20% by mass or less, and the potassium chloride concentration in the charging liquid is adjusted to 2 to 18% by mass. In order to produce a soy sauce product with lower sodium content, the sodium chloride concentration is preferably adjusted to 8 to 16% by mass, and the potassium chloride concentration is preferably adjusted to 6 to 14% by mass. If the amount of added potassium chloride is too small, putrefaction occurs in many cases during fermentation and aging, and a sufficient salty taste cannot be imparted. On the other hand, if the amount thereof is too large, unpleasant tastes of potassium chloride become excessively strong. In this process, a known putrefaction-preventing process maybe employed, such as adjustment of pH, addition of an alcohol, and addition of a salt substitute other than potassium chloride.

After completion of fermentation and aging of moromi, the moromi is squeezed to collect a pure soy sauce. In this aspect, the above-described taste-improving agent is added to the resultant pure soy sauce so that a basic amino acid and/or a basic peptide is contained in an amount of 0.01 to 1.0% by mass, preferably 0.01 to 0.4% by mass, and the pure soy sauce may be heated in accordance with a conventional method. Alternatively, the above-described taste-improving agent may be added after the pure soy sauce is heated in accordance with a conventional method.

In this aspect, fermentation and aging may be performed after the above-described taste-improving agent is added so that a basic amino acid and/or a basic peptide is contained in an amount of 0.015 to 2.0% by mass, preferably 0.015 to 0.6% by mass before the fermentation and aging.

Addition of the predetermined amount of a basic amino acid and/or a basic peptide can alleviate unpleasant tastes of potassium chloride and produce a soy sauce product having salty taste, umami, and a flavor which bear comparison with those of a normal soy sauce.

The basic amino acid is added in an amount of preferably 0.002 to 0.3% by mass of histidine, 0.004 to 0.7% by mass of arginine, and 0.006 to 1.0% by mass of lysine, more preferably 0.002 to 0.1% by mass of histidine, 0.004 to 0.2% by mass of arginine, and 0.006 to 0.3% by mass of lysine. Addition of the predetermined amount of histidine, arginine, and lysine can more effectively alleviate unpleasant tastes of potassium chloride.

Glutamic acid is further added in an amount of preferably 0.06% by mass or more, more preferably 0.06 to 2.5% by mass, even more preferably 0.06 to 1.0% by mass. Addition of the predetermined amount of glutamic acid can effectively improve harsh taste and bitter taste of potassium chloride, amino acid, and the like and produce a soy sauce product with more excellent umami and flavor.

In this aspect, it is preferable to further add GABA in an amount of 50 ppm or more, and in views of its effect of improving quality of taste, effect of enhancing salty taste, and effect of lowering blood pressure, GABA is more preferably added in an amount of 500 to 2,000 ppm.

Further, it is possible to add not only the above-described ingredients but also normal soy sauces, sweet cooking rice wine, miso, other seasonings, acidulant, flavor, stock, extracts, natural salts such as bittern and rock salt, fermented foods, and the like in appropriate amounts.

The soy sauce product obtained as above preferably contains sodium chloride in an amount of 9% by mass or less, more preferably contains sodium chloride in an amount of 9% by mass or less and total nitrogen in an amount of 1.9% by mass or less, even more preferably contains sodium chloride in an amount of 7.5 to 9% by mass and total nitrogen in an amount of 1.1 to 1.9% by mass. The soy sauce product obtained as above more preferably contains sodium chloride in an amount of 9% bymass or less, potassium chloride in an amount of 7% by mass or more, and total nitrogen in an amount of 1.9% by mass or more, even more preferably contains sodium chloride in an amount of 7.5 to 9% by mass, potassium chloride in an amount of 7 to 10% by mass, and total nitrogen in an amount of 1.9 to 3.0% by mass. In this aspect, charging for brewing may be performed such that the sodium chloride content in a soy sauce product be adjusted to within the above-described range, otherwise the content may be adjusted by adding a normal soy sauce, a reduced-salt/low-salt soy sauce, water, an alcohol, sodium chloride, potassium chloride, an amino acid, and the like after brewing. If the sodium chloride concentration is within the above range, an effect of reducing salt as much as that of a reduced-salt soy sauce of Japanese Agricultural Standards (JAS) can be obtained.

Another embodiment of the process for producing food and beverage containing potassium chloride of the present invention will be described using a case where the food and beverage containing potassium chloride are soy sauce products including a soy sauce with a sodium salt content adjusted by desalting.

In the present description, the soy sauce with a sodium salt content adjusted by desalting means a reduced-salt soy sauce or low-salt soy sauce obtained by: desalting a normal soy sauce in accordance with a conventional method by electrodialysis or using a membrane treatment apparatus; if necessary, concentrating the soy sauce and adding a normal soy sauce to adjust the sodium salt concentration to a predetermined value. The soy sauce has a sodium chloride concentration of, preferably 3 to 15% (w/w), more preferably 6 to 12% (w/w), most preferably 8 to 9% (w/w) in terms of sodium.

In this aspect, the process for producing a soy sauce product includes adjusting the glutamic acid content and basic amino acid content to predetermined values, by adding a predetermined amount of a potassium salt to the soy sauce with a sodium salt content adjusted by desalting, and by adding the above-described taste-improving agent.

In the present description, the “normal soy sauce” means light colored soy sauce, dark soy sauce, tamari soy sauce, saishikomi soy sauce, and white soy sauce of Japanese Agricultural Standards (JAS). The “reduced-salt soy sauce” means a soy sauce with a sodium chloride content of less than 9% (w/w) in terms of sodium, and the “low-salt soy sauce” means a soy sauce with a sodium chloride content of 9 to 14.5% (w/w) in terms of sodium.

The above-described potassium salt may be one that can be used as a food additive, and potassium chloride is preferably used. The adding amount of potassium salt may be corresponding to 9% (w/w) or more, preferably 50 to 200% (w/w), more preferably 100 to 160% (w/w), of the reducing value of sodium salt amount that is caused by the adjustment by desalting. If the amount of the added potassium salt is too small, salty taste cannot be sufficiently imparted, while if the amount is too large, unpleasant tastes of the potassium salt becomes too strong. Note that the amount of the sodium salt removed by adjustment by desalting can be determined by atomic absorption spectrophotometer.

The glutamic acid content can be determined by a process using an amino acid automatic analyzer, or the like, for example. In this aspect, the glutamic acid content is adjusted to be equal to or larger than the glutamic acid before adjustment by desalting. That is, the amount of glutamic acid in a soy sauce after adjustment by desalting is adjusted to be equal to or larger than the glutamic acid content in a normal soy sauce.

Specifically, in this aspect, the glutamic acid content is preferably adjusted to 500 to 5,000 mg/100 g, more preferably adjusted to 800 to 3,000 mg/100 g in terms of balance of taste, and particularly preferably adjusted to 900 to 1,400 mg/100 g. If the glutamic acid content in a soy sauce after adjustment by desalting is too small, the bitter taste and harsh taste of potassium, an amino acid, and the like are exhibited, while if the content is too large, the flavor of a soy sauce itself is reduced, which both are not preferable.

The contents of basic amino acids such as lysine, arginine, and histidine can be determined by a process using an amino acid automatic analyzer, etc., for example.

In this aspect, the arginine content in a soy sauce after adjustment by desalting is adjusted to −20 to +200 mg/100 g with respect to the content before adjustment by desalting; the histidine content is adjusted to −10 to +100 mg/100 g with respect to the content before adjustment by desalting; and the lysine content is adjusted to −30 to +300 mg/100 g with respect to the content before adjustment by desalting. Preferably, the arginine content is adjusted to −10 to +100 mg/100 g with respect to the content before adjustment by desalting; the histidine content is adjusted to −5 to +50 mg/100 g with respect to the content before adjustment by desalting; and the lysine content is adjusted to −15 to +150 mg/100 g with respect to the content before adjustment by desalting. Specifically, the arginine and lysine contents in the soy sauce after adjustment by desalting are preferably adjusted to 5 to 1,000 mg/100 g, respectively, and the histidine content is preferably adjusted to 5 to 500 mg/100 g. The arginine and lysine contents are more preferably adjusted to 10 to 800 mg/100 g, respectively, and the histidine content is more preferably adjusted to 10 to 400 mg/100 g. The arginine and lysine contents are particularly preferably adjusted to 50 to 600 mg/100 g, respectively, and the histidine content is particularly preferably adjusted to 20 to 300 mg/100 g. If the basic amino acid contents in the soy sauce after adjustment by desalting are beyond the above-mentioned ranges, the harsh taste and bitter taste of potassium are exhibited, while if the contents are too large, the bitter tastes of the basic amino acids are exhibited, which both are not preferable.

Further, γ-aminobutyrate (GABA) may be added to the above-described soy sauce product. In this aspect, it is preferable to adjust the GABA content to 50 ppm or more, and in terms of its effect of improving quality of taste, effect of enhancing salty taste, and effect of lowering blood pressure, it is more preferable to adjust the GABA content to 500 to 2,000 ppm.

It is possible to add not only the above-described ingredients but also a normal soy sauce, sweet cooking rice wine, miso, other seasonings, acidulant, flavor, stock, extracts, natural salts such as bittern and rock salt, fermented foods, and the like in appropriate amounts.

The soy sauce product obtained as above preferably has a salt content of 3 to 15% (w/w) in terms of sodium, a potassium chloride content of 13% (w/w) or less, a glutamic acid content of 500 to 5,000 mg/100 g, arginine and lysine contents of 5 to 1,000 mg/100 g, respectively, and a histidine content of 5 to 500 mg/100 g. More preferably, the product has a salt content of 6 to 12% (w/w) in terms of sodium, a potassium chloride content of 4 to 10% (w/w), a glutamic acid content of 800 to 3,000 mg/100 g, arginine and lysine contents of 10 to 800 mg/100 g, respectively, and a histidine content of 10 to 400 mg/100 g. Particularly preferably, the product has a salt content of 8 to 9% (w/w) in terms of sodium, a potassium chloride content of 6 to 8% (w/w), a glutamic acid content of 900 to 1,400 mg/100 g, arginine and lysine contents of 50 to 600 mg/100 g, respectively, and a histidine content of 20 to 300 mg/100 g.

### EXAMPLES

### Test Example 1

Ten panelists separately performed sensory evaluations for aqueous solutions obtained by dissolving an amino acid or a peptide in an aqueous solution containing 0.5% by mass of sodium chloride and 0.5% by mass of potassium chloride to evaluate the presence or absence of bitter taste/harsh taste and the presence or absence of foreign taste. The amounts of the amino acids and peptides were set based on threshold levels thereof in cases where they were singly dissolved.

The ten panelists evaluated the bitter/harsh tastes of the solutions based on the following criteria: none (3 points); slight (2 points), present but improved (1 point); no change (0 point); slightly deteriorated (−1 point); deteriorated (−2 point); significantly deteriorated (−3 point), and the results were shown as average points: A≧1 point>B≧1.5 points>C>0 point≧D, which were calculated from the points of the 10 panelists. The foreign tastes were evaluated based on the following criteria: none (3 points); slight (2 points); present (1 point); significant (0 point), and the results were shown as average points: A=3 points>B≧22.5 points>C>2 points≧D. The average points in the evaluations of the bitter/harsh tastes and the foreign tastes were summated to perform comprehensive evaluation, and the results were shown as A≧4 points>B≧3 points>C>2 points≧D. Note that the solutions evaluated as D on the bitter/harsh tastes were evaluated as D in comprehensive evaluation. The results are collectively shown in Table 1.

TABLE 1

| | | Bitter/ | | |
|---|---|---|---|---|
| | Amount | harsh | Foreign | Comprehensive |
| Amino acid/peptide | [% by mass] | taste | taste | evaluation |
| Arginine | 0.030 | A | A | A |
| Histidine | 0.040 | B | B | B |
| Histidine | 0.016 | A | A | A |
| hydrochloride | | | | |
| Lysine hydrochloride | 0.250 | B | B | B |
| Sodium glutamate | 0.010 | C | D | C |
| Glutamine | 0.800 | C | C | C |
| Sodium aspartate | 0.160 | D | C | D |
| Asparagine | 0.300 | D | B | D |
| Valine | 0.150 | D | D | D |
| Leucine | 0.050 | D | D | D |
| Isoleucine | 0.100 | D | C | D |
| Methionine | 0.025 | D | D | D |
| Alanine | 0.150 | B | D | C |
| Glycine | 0.120 | C | B | C |
| Threonine | 0.800 | D | B | D |
| Serine | 0.250 | D | C | D |
| Anserine | 0.010 | A | A | A |

The results shown in Table 1 revealed that addition of basic amino acids: arginine, histidine, histidine hydrochloride, and lysine hydrochloride, and a basic peptide: anserine to the aqueous solution containing potassium chloride could suppress the bitter/harsh tastes of potassium chloride without exhibiting the foreign tastes of the basic amino acids and basic peptide. In particular, arginine, histidine hydrochloride, and anserine were found to be excellent.

On the other hand, sodium glutamate, glutamine, alanine, and glycine were found to have effects of suppressing the bitter/harsh tastes of potassium chloride in some degree, but in all the cases, strong foreign tastes derived from the basic amino acids and basic peptides themselves were exhibited, resulting in occurrence of new foreign tastes.

### Test Example 2

According to the compositions shown in Table 2, the materials were mixed to produce salty seasonings. Note that the fish peptide was obtained from a bonito extract as a material by the following procedure: basic amino acids adsorbed to weakly acidic ion-exchange resin (DIAION WK-40: manufactured by Mitsubishi Chemical Corporation) were eluted with hydrochloric acid, and the eluate was neutralized and powderized (containing 80% sodium chloride, and as the basic amino acid/basic peptide, 4% anserine, 6% histidine, and 10% others).

TABLE 2

| Materials [kg] | Example 1 | Example 2 | Example 3 |
|---|---|---|---|
| Sodium chloride | 0.95 | 0.55 | 0.95 |
| Potassium chloride | 0.05 | 0.05 | 0.05 |
| Anserine | 0.02 | — | — |
| Histidine | 0.03 | — | — |
| Fish peptide | — | 0.50 | — |
| Total | 1.05 | 1.10 | 1.00 |

The salty seasonings of Examples 1 and 2 were found to have sufficiently suppressed bitter taste of potassium chloride compared with the salty seasoning of Example 3 containing no basic amino acid and/or basic peptide, and to have salty taste, which bears comparison with that of sodium chloride and to be extremely excellent salty seasonings.

### Test Example 3

According to the compositions shown in Table 3, soy sauce products were produced. As the low-salt soy sauce, there was used a soy sauce obtained by desalting a commercially-available dark soy sauce by electrodialysis until the salt content reached 3.0%. As potassium chloride, a crude product (72% of potassium chloride, 20% of sodium chloride, 8% of calcium salts/magnesium salts/others) was used.

TABLE 3

| Materials [kg] | Example 4 | Example 5 | Example 6 |
|---|---|---|---|
| Low-salt soy sauce | 1.605 | 1.595 | 0.95 |
| Sodium chloride | 0.032 | — | 0.95 |
| Potassium chloride | 0.320 | 0.220 | 0.05 |
| Histidine | 0.010 | — | — |
| Arginine | 0.013 | — | — |
| Lysine | 0.025 | — | — |
| Fish peptide | — | 0.185 | — |
| Total | 2.000 | 2.000 | 2.000 |

The soy sauce products of Examples 4 and 5 were found to have sufficiently suppressed bitter taste of potassium chloride compared with the soy sauce product of Example 6 containing no basic amino acid and/or basic peptide, and to have soy sauce taste with flavors, which bears comparison with that of a normal dark soy sauce.

### Test Example 4

Japanese domestic round soybean soy sauce (salt content: 14.7% (w/w)) was subjected to a desalting treatment using an electrodialyzer and concentrated, followed by adjustment of the salt content to 7.1% (w/w). Further, there was prepared a reduced-salt soy sauce with a salt content adjusted to 9.0% (w/w) by blending a dark soy sauce before desalting.

The salt content was determined by measuring the sodium content by atomic absorption spectrophotometer and converting the sodium content into the salt content.

Amino acid patterns of the soy sauce and reduced-salt soy sauce were determined using an amino-acid analyzer (product name “L-8500A” manufactured by Hitachi, Ltd.). The results are shown in Table 4.

TABLE 4

| | Sample name | | | |
|---|---|---|---|---|
| | Japanese domestic round | | | |
| | soybean soy sauce | | Reduced-salt soy sauce | |
| | Content | Composition | Content | Composition |
| Amino Acid | [mg/100 g] | [%] | [mg/100 g] | [%] |
| Taurine | 21.5 | 0.4 | 20.9 | 0.5 |
| Aspartic acid | 496.7 | 9.5 | 367.2 | 8.1 |
| Threonine | 243.7 | 4.6 | 228.9 | 5.0 |
| Serine | 356.0 | 6.8 | 334.4 | 7.3 |
| Glutamic acid | 737.6 | 14.0 | 574.2 | 12.6 |
| Glycine | 188.2 | 3.6 | 175.5 | 3.9 |
| Alanine | 335.1 | 6.4 | 314.9 | 6.9 |
| Valine | 354.7 | 6.8 | 331.0 | 7.3 |
| Methionine | 89.8 | 1.7 | 82.3 | 1.8 |
| Cystine | 0.0 | 0.0 | 0.0 | 0.0 |
| Isoleucine | 341.1 | 6.5 | 316.0 | 6.9 |
| Leucine | 537.5 | 10.2 | 502.8 | 11.0 |
| Tyrosine | 72.3 | 1.4 | 69.0 | 1.5 |
| Phenylalanine | 340.2 | 6.5 | 314.5 | 6.9 |
| Lysine | 318.0 | 6.1 | 232.2 | 5.1 |
| Histidine | 97.2 | 1.8 | 70.9 | 1.6 |
| Arginine | 399.9 | 7.6 | 317.1 | 7.0 |
| Proline | 324.8 | 6.2 | 305.1 | 6.7 |
| Total | 5,254.3 | 100.0 | 4,556.7 | 100.0 |

Compared the amino acid patterns of normal soy sauce with reduced-salt soy sauce based on the results shown in Table 4, it was found that the loss ratios of acidic and basic amino acids became larger after adjustment by desalting through electrodialysis.

To this reduced-salt soy sauce, potassium chloride, arginine, histidine, lysine, glutamic acid, and GABA were added and the compositions were adjusted to the values shown in Tables 5 to 8 to perform sensory evaluations.

Sensory evaluations were separately performed for the respective conditions in adding potassium chloride, and comprehensive evaluations were performed by the order method (Tables 5 to 7). The samples shown in Table 8 were used to evaluate effects of adding GABA.

TABLE 5

| | Amount of | | | | | | |
|---|---|---|---|---|---|---|---|
| | added | | | | | | |
| | potassium | Arginine | Histidine | Lysine | Glutamic acid | GABA | |
| Test | chloride | content | content | content | content | content | |
| Examples | (g/100 g) | (mg/100 g) | (mg/100 g) | (mg/100 g) | (mg/100 g) | (ppm) | Order |
| Example 7 | 0.5*¹ | 380 | 90 | 290 | 720 | 9 | 8 |
| Example 8 | | 390 | 95 | 305 | | | 6 |
| Example 9 | | 400 | 100 | 320 | | | 5 |
| Example 10 | | 440 | 120 | 380 | | | 7 |
| Example 11 | | 620 | 210 | 650 | | | 10 |
| Example 12 | | 380 | 90 | 290 | 820 | | 4 |
| Example 13 | | 390 | 95 | 305 | | | 2 |
| Example 14 | | 400 | 100 | 320 | | | 1 |
| Example 15 | | 440 | 120 | 380 | | | 3 |
| Example 16 | | 620 | 210 | 650 | | | 9 |

*¹9% of amount of reduced sodium chloride

TABLE 6

| | Amount of | | | | | | |
|---|---|---|---|---|---|---|---|
| | added | | | | | | |
| | potassium | Arginine | Histidine | Lysine | Glutamic acid | GABA | |
| Test | chloride | content | content | content | content | content | |
| Examples | (g/100 g) | (mg/100 g) | (mg/100 g) | (mg/100 g) | (mg/100 g) | (ppm) | Order |
| Example 17 | 8*² | 380 | 90 | 290 | 720 | 9 | 8 |
| Example 18 | | 390 | 95 | 305 | | | 6 |
| Example 19 | | 400 | 100 | 320 | | | 5 |
| Example 20 | | 440 | 120 | 380 | | | 7 |
| Example 21 | | 620 | 210 | 650 | | | 10 |
| Example 22 | | 380 | 90 | 290 | 820 | | 4 |
| Example 23 | | 390 | 95 | 305 | | | 2 |
| Example 24 | | 400 | 100 | 320 | | | 1 |
| Example 25 | | 440 | 120 | 380 | | | 3 |
| Example 26 | | 620 | 210 | 650 | | | 9 |

*²38% of amount of reduced sodium chloride

TABLE 7

| | Amount of | | | | | | |
|---|---|---|---|---|---|---|---|
| | added | | | | | | |
| | potassium | Arginine | Histidine | Lysine | Glutamic acid | GABA | |
| Test | chloride | content | content | content | content | content | |
| Examples | (g/100 g) | (mg/100 g) | (mg/100 g) | (mg/100 g) | (mg/100 g) | (ppm) | Order |
| Example 27 | 8*³ | 380 | 90 | 290 | 720 | 9 | 8 |
| Example 28 | | 390 | 95 | 305 | | | 7 |
| Example 29 | | 400 | 100 | 320 | | | 5 |
| Example 30 | | 440 | 120 | 380 | | | 6 |
| Example 31 | | 620 | 210 | 650 | | | 10 |
| Example 32 | | 380 | 90 | 290 | 820 | | 4 |
| Example 33 | | 390 | 95 | 305 | | | 3 |
| Example 34 | | 400 | 100 | 320 | | | 1 |
| Example 35 | | 440 | 120 | 380 | | | 2 |
| Example 36 | | 620 | 210 | 650 | | | 9 |

*³151% of amount of reduced sodium chloride

TABLE 8

| | Amount of | | | | | | |
|---|---|---|---|---|---|---|---|
| | added | | | | | | |
| | potassium | Arginine | Histidine | Lysine | Glutamic acid | GABA | |
| Test | chloride | content | content | content | content | content | |
| Examples | (g/100 g) | (mg/100 g) | (mg/100 g) | (mg/100 g) | (mg/100 g) | (ppm) | Order |
| Example 37 | 8 | 400 | 100 | 320 | 720 | 0 | 4 |
| Example 38 | | | | | 820 | | 2 |
| Example 39 | | | | | 720 | 50 | 3 |
| Example 40 | | | | | 820 | | 1 |

As is clear from the results shown in Tables 5 to 7, where respective conditions in adding potassium chloride were 0.5, 2, and 8% (w/W), adjustment of the contents of the amino acids such as glutamic acid, arginine, histidine, and lysine to ranges specified in the present description led to good evaluations. Further, as is clear from Table 8, when a large amount of glutamic acid was added, salty taste could be enhanced more effectively by salty taste-enhancing effect of GABA without reducing the flavor due to addition of GABA.

### Test Example 5

Japanese domestic round soybean soy sauce (salt content: 14.7% (w/w), Material 1) was subjected to a desalting treatment using an electrodialyzer and concentrated, to thereby yield a reduced-salt soy sauce with a salt content of 7.1% (w/w). The reduced-salt soy sauce was used as a base to blend the materials at the composition shown in Table 9, to thereby produce a soy sauce product (Composition 1).

Amino acid patterns of the soy sauce product of Composition 1, as well as those of the original soy sauce of Material 1, were determined using an amino-acid analyzer (product name “L-8500A”, Hitachi, Ltd.). The salt content and the potassium chloride content were analyzed using an atomic absorption spectroscope. The results are shown in Table 9.

TABLE 9

| Materials (% (w/w)) | Composition 1 | Material 1 |
|---|---|---|
| Reduced-salt soy sauce | 75.9% | |
| Material soy sauce | 14.7% | |
| Potassium chloride | 7.1% | |
| Protein hydrolysate (wheat) | 1.1% | |
| Seasoning extract | 0.7% | |
| Yeast extract | — | |
| GABA extract powder | — | |
| Flavor | 0.5% | |
| Salt concentration [% (w/w)] | 8.8 | 14.7 |
| Potassium chloride concentration | 7.1 | — |
| [% (w/w)] | | |
| Free amino acid concentration | | |
| [mg/100 g] | | |
| Taurine | 26.2 | 21.5 |
| Aspartic acid | 512.1 | 496.7 |
| Threonine | 261.1 | 243.7 |
| Serine | 382.9 | 356.0 |
| Glutamic acid | 962.0 | 737.6 |
| Glycine | 194.2 | 188.2 |
| Alanine | 325.2 | 335.1 |
| Valine | 377.0 | 354.7 |
| Cystine | 96.8 | 89.8 |
| Methionine | 0.0 | 0.0 |
| Isoleucine | 348.2 | 341.1 |
| Leucine | 576.7 | 537.5 |
| Tyrosine | 72.2 | 72.3 |
| Phenylalanine | 356.6 | 340.2 |
| Lysine | 315.3 | 318.0 |
| Histidine | 100.0 | 97.2 |
| Arginine | 398.0 | 399.9 |
| Proline | 363.5 | 324.8 |
| Total | 5667.9 | 5254.3 |

For the soy sauce product obtained by the above-described process, sensory evaluations were performed, and the product was found to have a flavor, which bears comparison with that of the material soy sauce.

### Test Example 6

Japanese domestic round soybean soy sauce (salt content: 14.2% (w/w), Material 2) was subjected to a desalting treatment using an electrodialyzer and concentrated, to thereby yield a reduced-salt soy sauce with a salt content of 7.6% (w/w). The reduced-salt soy sauce was used as a base to blend the materials at the composition shown in Table 10, to thereby produce a soy sauce product (Composition 2).

Amino acid patterns of the soy sauce product of Composition 2, as well as those of the original soy sauce of Material 2, were determined using an amino-acid analyzer (product name “L-8500A” manufactured by Hitachi, Ltd.). The salt content and the potassium chloride content were analyzed using an atomic absorption spectrophotometer. The results are shown in Table 10.

TABLE 10

| Materials (% (w/w)) | Composition 2 | Material 2 |
|---|---|---|
| Reduced-salt soy sauce | 60.0% | |
| Material soy sauce | 27.2% | |
| Potassium chloride | 7.5% | |
| Protein hydrolysate (wheat) | 2.8% | |
| Seasoning extract | — | |
| Yeast extract | 1.1% | |
| GABA extract powder | 1.1% | |
| Flavor | 0.3% | |
| Salt concentration [% (w/w)] | 8.9 | 14.2 |
| Potassium chloride concentration | 7.5 | — |
| [% (w/w)] | | |
| Free amino acid concentration | | |
| [mg/100 g] | | |
| Taurine | 20.7 | 18.1 |
| Aspartic acid | 422.9 | 411.4 |
| Threonine | 223.6 | 200.3 |
| Serine | 334.1 | 285.8 |
| Glutamic acid | 1329.3 | 875.8 |
| Glycine | 191.5 | 158.6 |
| Alanine | 309.1 | 283.8 |
| Valine | 301.1 | 292.2 |
| Cystine | 0.0 | 0.0 |
| Methionine | 83.0 | 83.9 |
| Isoleucine | 284.1 | 276.0 |
| Leucine | 482.2 | 438.2 |
| Tyrosine | 57.7 | 59.4 |
| Phenylalanine | 299.5 | 282.9 |
| Lysine | 265.0 | 264.8 |
| Histidine | 39.3 | 22.2 |
| Arginine | 241.3 | 233.6 |
| Proline | 373.8 | 247.8 |
| Total | 5258.2 | 4434.7 |

For the soy sauce product obtained by the above-described process, sensory evaluations were performed, and the product was found to have a flavor, which bears comparison with that of the material soy sauce.

### Test Example 7

A charging liquid with a sodium chloride concentration of 20% by mass and a potassium chloride concentration of 2% by mass was used to perform brewing/heating in accordance with a conventional method, thereby yielding a soy sauce. In this production step, there were no problems such as putrefaction in brewing and poor fermentation. Basic amino acids (arginine, histidine, and lysine) were added to the resultant soy sauce in a proportion shown in Table 11. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 11.

TABLE 11

| | Example 41 | Example 42 | Example 43 | Example 44 | Example 45 |
|---|---|---|---|---|---|
| Amount of added potassium | 2 | | | | |
| chloride (g/100 g) | | | | | |
| Amount of added histidine | 0 | 2 | 10 | 160 | 200 |
| (mg/100 g) | | | | | |
| Amount of added arginine | 0 | 4 | 20 | 320 | 400 |
| (mg/100 g) | | | | | |
| Amount of added lysine | 0 | 6 | 15 | 480 | 600 |
| (mg/100 g) | | | | | |
| Amount of added total basic | 0 | 12 | 45 | 960 | 1,200 |
| amino acids (mg/100 g) | | | | | |
| Evaluation order | 4 | 2 | 1 | 3 | 5 |

As is clear from Table 11, the samples of Examples 42 to 44, which contained the basic amino acids in amounts within the ranges specified in the present description, were highly evaluated compared with the samples of Examples 41 and 45.

Specifically, the sample of Example 43 was evaluated to have no bitter tastes of both potassium chloride and the basic amino acids and have a sufficient flavor of a soy sauce and was most highly evaluated. The sample of Example 42 was evaluated to have slight bitter taste of potassium chloride, and the sample of Example 44 was evaluated to have slight bitter tastes of the basic amino acids. However, in both the cases, there was no problem of the flavor of a soy sauce.

On the other hand, the sample of Example 41, which contained no basic amino acids, was evaluated to have the strong bitter taste of potassium chloride, and the sample of Example 45 was evaluated to have the strong bitter tastes of the basic amino acids due to excessive amounts of the basic amino acids and have significantly reduced flavor and umami of a soy sauce.

### Test Example 8

A charging liquid with a sodium chloride concentration of 12% by mass and a potassium chloride concentration of 10% by mass was used to perform brewing/heating in accordance with a conventional method, thereby yielding a soy sauce. In this production step, there were no problems such as putrefaction in brewing and poor fermentation. Basic amino acids (arginine, histidine, and lysine) were added to the resultant soy sauce in a proportion shown in Table 12. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 12.

TABLE 12

| | Example 46 | Example 47 | Example 48 | Example 49 | Example 50 |
|---|---|---|---|---|---|
| Amount of added potassium | 10 | | | | |
| chloride (g/100 g) | | | | | |
| Amount of added histidine | 0 | 2 | 10 | 160 | 200 |
| (mg/100 g) | | | | | |
| Amount of added arginine | 0 | 4 | 20 | 320 | 400 |
| (mg/100 g) | | | | | |
| Amount of added lysine | 0 | 6 | 15 | 480 | 600 |
| (mg/100 g) | | | | | |
| Amount of added total basic | 0 | 12 | 45 | 960 | 1,200 |
| amino acids (mg/100 g) | | | | | |
| Evaluation order | 4 | 2 | 1 | 3 | 5 |

As is clear from Table 12, the samples of Examples 47 to 49, which contained the basic amino acids in amounts within the ranges specified in the present description, were highly evaluated compared with the samples of Examples 46 and 50.

Specifically, the sample of Example 48 was evaluated to have no bitter tastes of both potassium chloride and the basic amino acids and have a sufficient flavor of a soy sauce and was most highly evaluated. The sample of Example 47 was evaluated to have slight bitter taste of potassium chloride, and the sample of Example 49 was evaluated to have slight bitter tastes of the basic amino acids. However, in both the cases, there was no problem of the flavor of a soy sauce.

On the other hand, the sample of Example 46, which contained no basic amino acids, was evaluated to have the strong bitter taste of potassium chloride, and the sample of Example 50 was evaluated to have the strong bitter tastes of the basic amino acids due to excessive amounts of the basic amino acids and have significantly reduced flavor and umami of a soy sauce.

### Test Example 9

A charging liquid with a sodium chloride concentration of 4% by mass and a potassium chloride concentration of 18% by mass was used to perform brewing/heating in accordance with a conventional method, thereby yielding a soy sauce. In this production step, there were no problems such as putrefaction in brewing and poor fermentation. Basic amino acids (arginine, histidine, and lysine) were added to the resultant soy sauce in a proportion shown in Table 13. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 13.

TABLE 13

| | Example 51 | Example 52 | Example 53 | Example 54 | Example 55 |
|---|---|---|---|---|---|
| Amount of added potassium | 18 | | | | |
| chloride (g/100 g) | | | | | |
| Amount of added histidine | 0 | 2 | 10 | 160 | 200 |
| (mg/100 g) | | | | | |
| Amount of added arginine | 0 | 4 | 20 | 320 | 400 |
| (mg/100 g) | | | | | |
| Amount of added lysine | 0 | 6 | 15 | 480 | 600 |
| (mg/100 g) | | | | | |
| Amount of added total basic | 0 | 12 | 45 | 960 | 1,200 |
| amino acids (mg/100 g) | | | | | |
| Evaluation order | 4 | 2 | 1 | 3 | 5 |

As is clear from Table 13, the samples of Examples 52 to 54, which contained the basic amino acids in amounts within the ranges specified in the present description, were highly evaluated compared with the samples of Examples 51 and 55.

Specifically, the sample of Example 53 was evaluated to have no bitter tastes of both potassium chloride and the basic amino acids and have a sufficient flavor of a soy sauce and was most highly evaluated. The sample of Example 52 was evaluated to have slight bitter taste of potassium chloride, and the sample of Example 54 was evaluated to have slight bitter tastes of the basic amino acids. However, in both the cases, there was no problem of the flavor of a soy sauce.

On the other hand, the sample of Example 51, which contained no basic amino acids, were evaluated to have the strong bitter taste of potassium chloride, and the sample of Example 55 was evaluated to have the strong bitter tastes of the basic amino acids due to excessive amounts of the basic amino acids and have significantly reduced flavor and umami of a soy sauce.

### Test Example 10

Basic amino acids (arginine, histidine, and lysine) were added to a charging liquid with a sodium chloride concentration of 20% by mass and a potassium chloride concentration of 2% by mass in a proportion shown in Table 14, and then brewing/heating was performed in accordance with a conventional method, thereby yielding a soy sauce. In this production step, there were no problems such as putrefaction in brewing and poor fermentation. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 14.

TABLE 14

| | Example 56 | Example 57 | Example 58 | Example 59 | Example 60 |
|---|---|---|---|---|---|
| Amount of added potassium | 2 | | | | |
| chloride (g/100 g) | | | | | |
| Amount of added histidine | 0 | 3 | 15 | 88 | 400 |
| (mg/100 g) | | | | | |
| Amount of added arginine | 0 | 6 | 29 | 175 | 800 |
| (mg/100 g) | | | | | |
| Amount of added lysine | 0 | 9 | 22 | 263 | 1,200 |
| (mg/100 g) | | | | | |
| Amount of added total basic | 0 | 18 | 66 | 526 | 2,400 |
| amino acids (mg/100 g) | | | | | |
| Evaluation order | 4 | 2 | 1 | 3 | 5 |

As is clear from Table 14, the samples of Examples 57 to 59, which contained the basic amino acids in amounts within the ranges specified in the present description, were highly evaluated compared with the samples of Examples 56 and 60.

Specifically, the sample of Example 58 was evaluated to have no bitter tastes of both potassium chloride and the basic amino acids and have a sufficient flavor of a soy sauce and was most highly evaluated. The sample of Example 57 was evaluated to have slight bitter taste of potassium chloride, and the sample of Example 59 was evaluated to have slight bitter tastes of the basic amino acids. However, in both the cases, there was no problem of the flavor of a soy sauce.

On the other hand, the sample of Example 56, which contained no basic amino acids, were evaluated to have the strong bitter taste of potassium chloride, and the sample of Example 60 was evaluated to have the strong bitter tastes of the basic amino acids due to excessive amounts of the basic amino acids and have significantly reduced flavor and umami of a soy sauce.

### Test Example 11

Basic amino acids (arginine, histidine, and lysine) were added to a charging liquid with a sodium chloride concentration of 12% by mass and a potassium chloride concentration of 10% by mass in a proportion shown in Table 15, and then brewing/heating was performed in accordance with a conventional method, thereby yielding a soy sauce. In this production step, there were no problems such as putrefaction in brewing and poor fermentation. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 15.

TABLE 15

| | Example 61 | Example 62 | Example 63 | Example 64 | Example 65 |
|---|---|---|---|---|---|
| Amount of added potassium | 10 | | | | |
| chloride (g/100 g) | | | | | |
| Amount of added histidine | 0 | 3 | 15 | 88 | 400 |
| (mg/100 g) | | | | | |
| Amount of added arginine | 0 | 6 | 29 | 175 | 800 |
| (mg/100 g) | | | | | |
| Amount of added lysine | 0 | 9 | 22 | 263 | 1,200 |
| (mg/100 g) | | | | | |
| Amount of added total basic | 0 | 18 | 66 | 526 | 2,400 |
| amino acids (mg/100 g) | | | | | |
| Evaluation order | 4 | 2 | 1 | 3 | 5 |

As is clear from Table 15, the samples of Examples 62 to 64, which contained the basic amino acids in amounts within the ranges specified in the present description, were highly evaluated compared with the samples of Examples 61 and 65.

Specifically, the sample of Example 63 was evaluated to have no bitter tastes of both potassium chloride and the basic amino acids and have a sufficient flavor of a soy sauce and was most highly evaluated. The sample of Example 62 was evaluated to have slight bitter taste of potassium chloride, and the sample of Example 64 was evaluated to have slight bitter tastes of the basic amino acids. However, in both the cases, there was no problem of the flavor of a soy sauce.

On the other hand, the sample of Example 61, which contained no basic amino acids, was evaluated to have the strong bitter taste of potassium chloride, and the sample of Example 65 was evaluated to have the strong bitter tastes of the basic amino acids due to excessive amounts of the basic amino acids and have significantly reduced flavor and umami of a soy sauce.

### Test Example 12

Basic amino acids (arginine, histidine, and lysine) were added to a charging liquid with a sodium chloride concentration of 4% by mass and a potassium chloride concentration of 18% by mass in a proportion shown in Table 16, and then brewing/heating was performed in accordance with a conventional method, thereby yielding a soy sauce. In this production step, there were no problems such as putrefaction in brewing and poor fermentation. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 16.

TABLE 16

| | Example 66 | Example 67 | Example 68 | Example 69 | Example 70 |
|---|---|---|---|---|---|
| Amount of added potassium | 18 | | | | |
| chloride (g/100 g) | | | | | |
| Amount of added histidine | 0 | 3 | 15 | 88 | 400 |
| (mg/100 g) | | | | | |
| Amount of added arginine | 0 | 6 | 29 | 175 | 800 |
| (mg/100 g) | | | | | |
| Amount of added lysine | 0 | 9 | 22 | 263 | 1,200 |
| (mg/100 g) | | | | | |
| Amount of added total basic | 0 | 18 | 66 | 526 | 2,400 |
| amino acids (mg/100 g) | | | | | |
| Evaluation order | 4 | 2 | 1 | 3 | 5 |

As is clear from Table 16, the samples of Examples 67 to 69, which contained the basic amino acids in amounts within the ranges specified in the present description, were highly evaluated compared with the samples of Examples 66 and 70.

Specifically, the sample of Example 68 was evaluated to have no bitter tastes of both potassium chloride and the basic amino acids and have a sufficient flavor of a soy sauce and was most highly evaluated. The sample of Example 67 was evaluated to have slight bitter taste of potassium chloride, and the sample of Example 69 was evaluated to have slight bitter tastes of the basic amino acids. However, in both the cases, there was no problem of the flavor of a soy sauce.

On the other hand, the sample of Example 66, which contained no basic amino acids, were evaluated to have the strong bitter taste of potassium chloride, and the sample of Example 70 was evaluated to have the strong bitter tastes of the basic amino acids due to excessive amounts of the basic amino acids and have significantly reduced flavor and umami of a soy sauce.

### Test Example 13

A charging liquid with a sodium chloride concentration of 12% by mass and a potassium chloride concentration of 10% by mass was used to perform brewing/heating in accordance with a conventional method, thereby yielding a soy sauce. In this production step, there were no problems such as putrefaction in brewing and poor fermentation. Basic amino acids (arginine, histidine, and lysine), glutamic acid, and GABA were added to the resultant soy source in the proportion shown in Table 17. For each sample, 14 panelists performed sensory evaluations. Sensory evaluations were performed in terms of umami, flavor, bitter taste, and salty taste, and comprehensive evaluations of them were recapitulated by the order method. The results are collectively shown in Table 17.

TABLE 17

| | Exam- | Example | Example | Exam- |
|---|---|---|---|---|
| | ple 48 | 71 | 72 | ple 73 |
| Amount of added potassium | 10 | | | |
| chloride (g/100 g) | | | | |
| Amount of added histidine | 10 | | | |
| (mg/100 g) | | | | |
| Amount of added arginine | 20 | | | |
| (mg/100 g) | | | | |
| Amount of added lysine | 15 | | | |
| (mg/100 g) | | | | |
| Amount of added total basic | 45 | | | |
| amino acids (mg/100 g) | | | | |
| Glutamic acid content | 0 | | 100 | |
| (mg/100 g) | | | | |
| GABA content (ppm) | 0 | 50 | 0 | 50 |
| Evaluation order | 4 | 3 | 2 | 1 |

As is clear from Table 17, the samples of Examples 71 to 73, which contained glutamic acid and/or GABA, were highly evaluated compared with the sample of Example 48, which contained no glutamic acid and GABA.

Specifically, the sample of Example 71, which contained only GABA, was evaluated to have strong salty taste and improved flavor of a soy sauce but have slightly reduced umami, and the sample of Example 72, which contained only glutamic acid, was evaluated to have more improved umami of a soy sauce. In addition, the sample of Example 73, which contained both glutamic acid and GABA, was evaluated to have stronger umami and salty taste of a soy sauce and have more improved flavor and umami.

### Test Example 14

A charging liquid with a sodium chloride concentration of 12% by mass and a potassium chloride concentration of 10% by mass was used to perform brewing/heating in accordance with a conventional method, thereby yielding a soy sauce. In this production step, there were no problems such as putrefaction in brewing and poor fermentation. By adding water to the resultant soy sauce, the potassium chloride concentration was adjusted to 9%, and then arginine, histidine, and lysine were added with 0.02% by mass, 0.01% by mass, and 0.015% by mass, respectively, to thereby yield a soy sauce product. The sodium chloride concentration, potassium chloride concentration, and total nitrogen content in this soy sauce product were measured and found to be 7.9%, 6.7%, and 1.5%, respectively. Note that the sodium chloride concentration and potassium chloride concentration were analyzed by atomic absorption spectrophotometer, and the total nitrogen content was analyzed by the semi-micro Kjeldahl method. The soy sauce product was evaluated to have good taste, which bears comparison with that of a normal soy sauce.

### Test Example 15

A charging liquid with a sodium chloride concentration of 12% by mass and a potassium chloride concentration of 10% by mass was used to perform brewing/heating in accordance with a conventional method, thereby yielding a soy sauce. In this production step, there were no problems such as putrefaction in brewing and poor fermentation. To the resultant soy sauce, water, an aqueous solution containing 10% by mass of potassium chloride, and a seasoning solution containing arginine, histidine, lysine, glutamic acid, etc. (amino acid solution) were added such that the sodium chloride content was adjusted to 9%, and the basic amino acid contents were adjusted as follows: 0.02% by mass of arginine, 0.01% by mass of histidine, and 0.015% by mass of lysine, to thereby yield a soy sauce product. The sodium chloride concentration, potassium chloride concentration, and total nitrogen content in this soy sauce product were measured and found to be 8.9%, 8.0%, and 2.0%, respectively. Note that the sodium chloride concentration and potassium chloride concentration were analyzed by atomic absorption spectrophotometer, and the total nitrogen content was analyzed by the semi-micro Kjeldahl method. The soy sauce product was evaluated to have good taste, which bears comparison with that of a normal soy sauce.

### INDUSTRIAL APPLICABILITY

According to the present invention, it is possible to produce food and beverage containing potassium chloride, which have a low-sodium content but have salty taste, umami, and flavor which bear comparison with those of normal food and beverage, and the food and beverage can be suitably used not only for people with salt restricted diets for alleviating high-blood pressure or the like but also for healthy subjects for the purpose of prevention of high-blood pressure or the like.

1. A taste-improving agent for food and beverage containing potassium chloride, comprising at least one of a basic amino acid and a basic peptide as an active ingredient.

2. A taste-improving agent for food and beverage containing potassium chloride according to claim 1, wherein the basic amino acid comprises one or more kinds selected from the group consisting of histidine, arginine, and lysine.

3. A taste-improving agent for food and beverage containing potassium chloride according to claim 1 or 2, wherein the basic peptide comprises one or more kinds selected from the group consisting of anserine, carnosine and balenine.

4. A taste-improving agent for food and beverage containing potassium chloride according to any one of claims 1 to 3, comprising the basic amino acid, the basic peptide, or both of the basic amino acid and the basic peptide in an amount of 0.05 to 99% by mass.

5. A taste-improving agent for food and beverage containing potassium chloride according to any one of claims 1 to 4, comprising as a main ingredient a material of a yeast extract, HVP, HAP, or a separated and purified product thereof, wherein the material contains the basic amino acid, the basic peptide, or both of the basic amino acid and the basic peptide in an amount of 2 to 99% by mass.

6. A taste-improving agent for food and beverage containing potassium chloride according to any one of claims 1 to 5, further comprising a glutamic acid in an amount of 0.1 to 50% by mass.

7. A taste-improving agent for food and beverage containing potassium chloride according to any one of claims 1 to 6, further comprising a γ-aminobutyric acid in an amount of 0.1 to 50% by mass.

8. A process for producing food and beverage containing potassium chloride, comprising adding the taste-improving agent according to any one of claims 1 to 7.

9. A process for producing food and beverage containing potassium chloride according to claim 8, wherein the taste-improving agent is added such that a basic amino acid, a basic peptide, or both of a basic amino acid and a basic peptide is contained in an amount of 0.2 to 200 parts by mass with respect to 100 parts by mass of potassium chloride.

10. A process for producing food and beverage containing potassium chloride according to claim 8 or 9, wherein the taste-improving agent is added to food and beverage which has a potassium chloride/sodium chloride mass ratio of 5/95 to 80/20.

11. A process for producing food and beverage containing potassium chloride according to any one of claims 8 to 10, wherein the food and beverage containing potassium chloride comprises a soy sauce product, the process further comprising: in a brewing process, preparing a charging liquid having a sodium chloride content of 20% by mass or less and a potassium chloride content of 2 to 18% by mass; performing fermentation and aging of the charging liquid to produce a soy sauce; adding the taste-improving agent to the soy sauce such that the basic amino acid, the basic peptide, or both of the basic amino acid and the basic peptide is added in an amount of 0.01 to 1.0% by mass.

12. A process for producing food and beverage containing potassium chloride according to any one of claims 8 to 10, wherein the food and beverage containing potassium chloride comprises a soy sauce product, the process further comprising: in a brewing process, preparing a charging liquid having a sodium chloride content of 20% by mass or less and a potassium chloride content of 2 to 18% by mass; adding the taste-improving agent to the charging liquid such that the basic amino acid, the basic peptide, or both of the basic amino acid and the basic peptide is added in an amount of 0.01 to 1.0% by mass; and performing fermentation and aging of the charging liquid to produce a soy sauce.

13. A process for producing food and beverage containing potassium chloride according to claim 11 or 12, wherein the basic amino acid comprising histidine, arginine, and lysine is added in amounts of 0.002 to 0.3% by mass, 0.004 to 0.7% by mass, and 0.006 to 1.0% by mass, respectively.

14. A process for producing food and beverage containing potassium chloride according to any one of claims 11 to 13, further comprising adding a glutamic acid in an amount of 0.06% by mass or more.

15. A process for producing food and beverage containing potassium chloride according to any one of claims 11 to 14, further comprising adding a γ-aminobutyric acid in an amount of 50 ppm or more.

16. A process for producing food and beverage containing potassium chloride according to any one of claims 8 to 10, wherein the food and beverage containing potassium chloride comprises a soy sauce product, the process further comprising: i) adding a potassium salt to a soy sauce, the sodium salt content of the soy sauce adjusted by desalting, wherein the potassium salt is added in an amount corresponding to 9% (w/w) or more of the reducing value of sodium salt amount, ii) adjusting a glutamic acid content to at least a value before the adjustment by desalting, and iii) adjusting: an arginine content to −20 to +200 mg/100 g relative to that before the adjustment by desalting; a histidine content to −10 to +100 mg/100 g relative to that before the adjustment by desalting; and a lysine content to −30 to +300 mg/100 g relative to that before the adjustment by desalting.

17. A process for producing food and beverage containing potassium chloride according to claim 16, further comprising adjusting a γ-aminobutyric acid content to 50 ppm or more and a glutamic acid content to 800 mg/100 g or more.

18. Food and beverage containing potassium chloride, comprising the taste-improving agent according to any one of claims 1 to 7.

19. Food and beverage containing potassium chloride according to claim 18, which contains the taste-improving agent such that a basic amino acid and a basic peptide is contained in an amount of 0.2 to 100 parts by mass with respect to 100 parts by mass of potassium chloride.

20. Food and beverage containing potassium chloride according to claim 18 or 19, which has a potassium chloride/sodium chloride mass ratio of 5/95 to 80/20.

21. Food and beverage containing potassium chloride according to any one of claims 18 to 20, which comprises a soy sauce product obtained by the production method according to any one of claims 11 to 15 and having a sodium chloride content of 9% by mass or less.

22. Food and beverage containing potassium chloride according to any one of claims 18 to 20, which comprises a soy sauce product obtained by the production method according to claim 16 or 17 and having a salt content of 3 to 15% (w/w) in terms of sodium, a potassium chloride content of 13% (w/w) or less, a glutamic acid content of 500 to 5,000 mg/100 g, an arginine content of 5 to 1,000 mg/100 g, a lysine content of 5 to 1,000 mg/100 g, and a histidine content of 5 to 500 mg/100 g.
